(19) United States
(12) Patent Application Publication
(10) Pub. No.: US 2024/0141643 A1
(43) Pub. Date: May 2, 2024

(54) CANOPY ROOFING SYSTEM

(71) Applicant: HELLEBOSCH, naamloze vennootschap, Brasschaat (BE)

(72) Inventor: Jan Hellebosch, Brasschaat (BE)

(73) Assignee: HELLEBOSCH, naamloze vennootschap, Brasschaat (BE)

(21) Appl. No.: 18/279,713

(22) PCT Filed: Jan. 13, 2022
(86) PCT No.: PCT/IB2022/050262

§ 371 Date: Aug. 31, 2023

(30) Foreign Application Priority Data
Mar. 1, 2021 (BE) 2021/5145

(51) Int. Cl. E04B 7/16

(52) U.S. Cl. CPC E04B 7/163

(57) ABSTRACT

Canopy roofing system which includes at least two successive pairs of panels, each pair of panels includes two panels resting directly or indirectly against each other, the panels of each pair are mutually hingedly and angularly connected along their facing edges by a top hinge including a curved shaft, at least one panel of each of the successive pairs of panels is mutually hingedly connected along their upwardly oriented edges, the upwardly oriented edges extend between the facing edges and the edges located opposite the aforementioned facing edges.

### CROSS-REFERENCE TO RELATED APPLICATIONS

The present application is the National Phase entry of International Patent Application No. PCT/IB2022/050262 filed Jan. 13, 2022, which claims priority to Belgium Patent Application No. 2021/5145 filed Mar. 1, 2021, the entire contents of both are hereby incorporated by reference into this application.

### TECHNICAL FIELD

The present disclosure relates to a canopy roofing system.

### BACKGROUND

In particular, the present disclosure is intended to provide a canopy which can be easily pushed away or removed.

It is known that such canopy roofing systems can be used in many applications, both in more domestic applications with compact size, and in more industrial or larger applications.

CN210685219U describes such a canopy, which consists of a number of panels which are folded up in accordion fashion. The panels are provided with solar cells or are solar panels, such that energy can also be generated.

The panels have a rotating shaft around which the panels can tilt, said rotating shaft being located in the middle of a side edge of the panels. In this way the panels are folded up in accordion fashion.

Such canopy roofing system allows the panels to be folded up or away depending on the wishes or needs and can be used as a kind of sunblind to close off or cover openings, like a type of movable roof.

The disadvantage of such known installations is that it is not possible to span or cover very long distances.

Indeed, if the distances are too long the panels will sag in the middle.

Therefore, in case of longer distances a centre support often needs to be applied or several of such canopy roofing systems need to be installed adjoiningly.

However, in some applications it is necessary that the distance that needs to be spanned is sufficiently long.

The purpose of the present disclosure is to provide a solution to at least one of the aforementioned and other disadvantages.

### SUMMARY

The object of the present disclosure is a canopy roofing system which comprises at least two successive pairs of panels, whereby each pair of panels comprises two panels resting directly or indirectly against each other, whereby the panels of each pair are mutually hingedly and angularly connected along their facing edges by a top hinge comprising a curved shaft, whereby at least one panel of each of the successive pairs of panels is mutually hingedly connected along their upwardly oriented edges, whereby said upwardly oriented edges extend between the facing edges and the edges located opposite the aforementioned facing edges.

The panels resting upwardly against each other will be angularly installed relative to each other. This angle is determined by the aforementioned curved shaft of the top hinge.

This provides an aspect that the forces offset each other because the panels rest against each other upwardly and are hingeably connected to each other on the facing edges, such that a longer distance can be bridged without the need of a centre support and the panels can still be tilted to temporarily remove or open the canopy.

Consequently, the applications of such canopy roofing system become much broader.

They can be used to bridge long distances, such that they can be used as a canopy for motorways, for agricultural fields, sports fields and the like.

The panels will also be able to tilt by hinging around the top hinge, such that the pairs of panels can be folded up in accordion fashion. When there are several pairs of panels, rows of panels will be formed in such way, whereby each row of panels can be folded up and open in accordion fashion.

In some embodiments, the panels of each pair are mutually hingedly and angularly connected in the middle of their facing edges by the aforementioned top hinge comprising a curved shaft.

As the aforementioned top hinge is installed in the middle of the facing edge, the panel will always be balanced when it hinges relative to the curved shaft. Therefore, no gravity resultant needs to be overcome in any position of the panels during their tilting movement.

In some embodiments, each panel on the edge located opposite the aforementioned facing edge is hingeably connected either to a support or to adjoining successive pairs of panels.

When the panel is connected to an adjoining successive pair of panels, a very wide arc-shaped canopy can be realised.

The two outer panels of the arc can then be provided with an aforementioned support, with which the canopy can rest on an underlying structure.

This support can have many different forms and can for example also be a carriage, wheel or post.

In some embodiments, the canopy roofing system comprises two parallel supporting profiles arranged at a distance from each other and the supports of the two panels are each provided on one of said supporting profiles.

In some embodiments, said support is provided with a gliding element, rolling element or wheel which allows the support to be movable on or in the supporting profile.

In this way a kind of lean-to can be made with the canopy roofing system, whereby the panels can be slid to the desired position.

This means that the canopy roofing system can be moved over the supporting profiles.

Furthermore, by shifting the supports in or over the supporting profiles toward or away from each other, the panels can also be tilted.

In a practical embodiment the canopy roofing system comprises more than two pairs of panels resting directly or indirectly against each other, all this such that two rows of panels resting against each other are formed, whereby the successive panels of at least one row are mutually hingedly connected along their upwardly oriented edges, whereby said upwardly oriented edges extend between the facing edges and the edges located opposite the aforementioned facing edges.

Such embodiment allows long distances to be covered or spanned.

This provides the aspect that by resting the panels upwardly against each other and making them hingeable in the middle of their facing edge, they can still be folded in accordion fashion, even if they are not lying in the same plane.

Furthermore, it is possible that there are more than two rows of panels by hingeably connecting a panel on the edge located opposite the aforementioned facing edge to adjoining successive pairs of panels, as aforementioned.

The applications of such system can be found in cargo hold canopies for barges, canopies for motorways, agricultural fields, sports fields, parks and the like.

The flexibility of the canopy roofing system, whereby the rows of panels can be very simply folded up and moved over the supporting profiles, increases the application possibilities immensely.

Furthermore, the system allows additional functionalities to be added, as will be discussed later in more detail.

### BRIEF DESCRIPTION OF THE DRAWINGS

With the intention of better showing the characteristics of the present disclosure, a few embodiments of a canopy roofing system according to the present disclosure are described hereinafter by way of an example, without any limiting nature, with reference to the accompanying drawings, wherein:

FIG. 1a schematically shows a perspective view of an embodiment of a canopy roofing system according to the present disclosure;

FIG. 1b schematically shows another perspective view of the embodiment of a canopy roofing system according to the present disclosure;

FIG. 1c shows a detail of a top hinge of the canopy roofing system according to the present disclosure;

FIG. 2a schematically shows a perspective view of a variant of the canopy roofing system shown in FIG. 1a;

FIG. 2b schematically shows a perspective view of a variant of the canopy roofing system shown FIG. 1b;

FIG. 3a schematically shows a perspective view of a variant of the canopy roofing system shown in FIG. 2a;

FIG. 3b schematically shows a perspective view of a variant of the canopy roofing system shown in FIG. 2b;

FIG. 4 schematically shows a very big embodiment of a canopy roofing system according to the present disclosure;

FIG. 5a schematically shows a perspective view of a practical realisation of the canopy roofing system shown in FIG. 4;

FIG. 5b schematically shows another perspective view of a practical realisation of the canopy roofing system shown in FIG. 4;

FIG. 5c schematically shows still another perspective view of a practical realisation of the canopy roofing system shown in FIG. 4;

FIG. 6a shows a perspective view of a practical application of a canopy roofing system according to the present disclosure as a cargo hold canopy;

FIG. 6b shows another perspective view of a practical application of a canopy roofing system according to the present disclosure as a cargo hold canopy;

FIG. 7a schematically shows a perspective view of a variant of the canopy roofing system shown in FIG. 4;

FIG. 7b schematically shows another perspective view of a variant of the canopy roofing system shown in FIG. 4.

### DETAILED DESCRIPTION

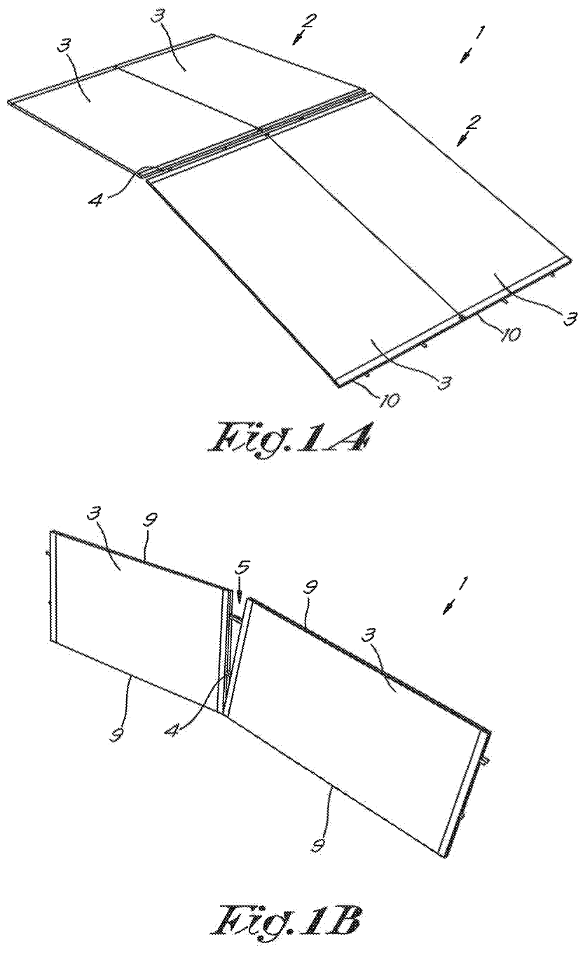

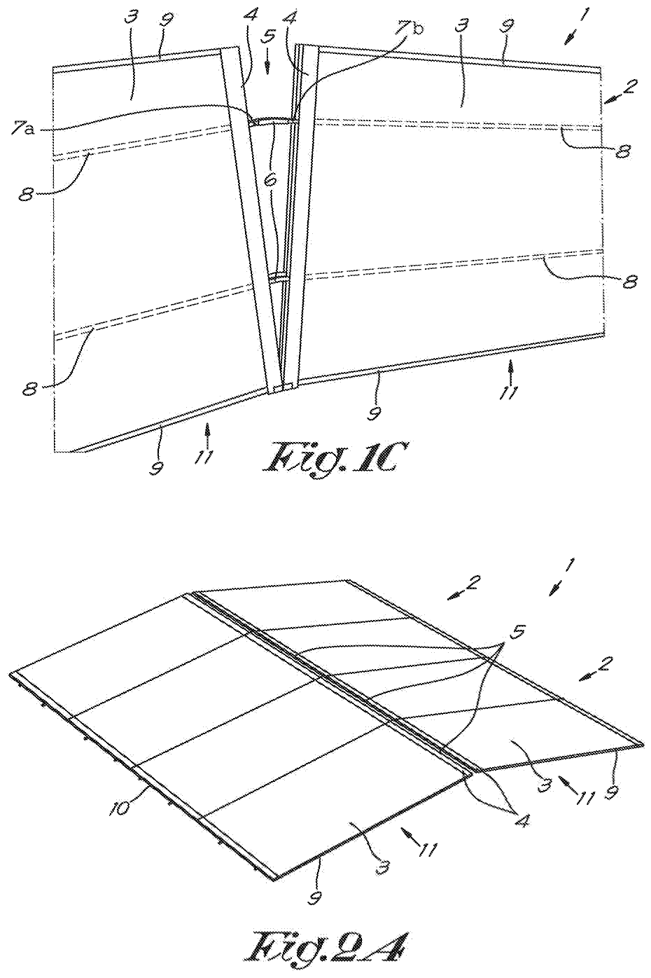

FIGS. 1a and 1b schematically and by way of example, show an embodiment of a canopy roofing system 1 according to the present disclosure.

The canopy roofing system 1 includes two pairs 2 of successive panels 3.

Each pair 2 comprises two panels 3 resting directly or indirectly against each other.

The panels 3 of each pair 2 are mutually hingedly and angularly connected along their facing edges 4 by a top hinge 5 comprising a curved shaft 6, as shown in FIGS. 1b and 1c.

Due to said curved shaft 6, the two panels 3 of each pair 2 will be angular relative to each other.

As shown in FIG. 1b, two such curved shafts 6 are provided for each pair 2 of panels 3, i.e. for every top hinge. This is not necessary according to the present disclosure. As shown later it is also possible that only one curved shaft 6 is provided per top hinge 5, whereby said curved shaft 6 can be located in the middle of the facing edges 4.

FIG. 1c shows a detail of the top hinge 5.

In this case, but not necessarily for the present disclosure, every aforementioned curved shaft 6 of the top hinge 5 is able to rotate with its free ends 7a, 7b in two supporting tubes 8, each provided to one panel 3 of the relevant pair 2 of panels 3, whereby the supporting tubes 8 extend in the direction of the upwardly oriented edges 9 of the panels 3.

Furthermore, in this case the free ends 7a, 7b of the curved shafts 6 will also be able to move in an axial direction in the two supporting tubes 8.

As a result of this, the facing edges 4 will be able to rotate around said shaft 6, all this such that by said rotation the one end of the edge 4 of the one panel 3 comes to lie closer against the one end of the edge 4 of the other panel 3 while the two other ends of the facing edges 4 come to lie further away from each other, whereby the upwardly oriented edges 9 of the one panel 3 remain at the same angle as the upwardly oriented edges 9 of the other panel 3 during said rotation.

During said movement the ends 7a, 7b for one curved shaft 6 will also slide further out of the supporting tubes 8, while for the other curved shaft 6 the ends 7a, 7b will be able to slide deeper into the supporting tubes 8.

Thank to this principle, whereby the curved shaft 6 is able to slide in and out of the relevant supporting tubes 8, the panels 3 will be able to tilt as shown in FIG. 1b.

It is also possible, but not necessary for the present disclosure, that the aforementioned top hinge 5 is provided with a flexible canvas, tarpaulin or the like which is applied between at least a section of the two facing edges 4 of the two panels 3 resting upwardly against each other.

This will ensure that the open spaces between the two facing edges 4 of each pair 2 of panels 3 are covered.

At least one panel 3 of each of the successive pairs 2 of panels 3, and in this case both panels 3 of each pair 2, are mutually hingedly connected along their upwardly oriented edges 9. These upwardly oriented edges 9 extend between the facing edges 4 and the edges 10 located opposite said facing edges 4.

Thanks to said hinged operation, the panels 3 can be folded up or together, as shown in FIG. 1b.

FIG. 1a shows the situation of the panels 3 folded open and FIG. 1b the situation of the panels 3 folded up.

In some embodiments, the hinged connection between the successive panels 3 is realised by an intermediate hinge, whereby the intermediate hinges are such that they allow the panels 3 to be folded toward each other in accordion fashion.

It may be clear that said intermediate hinge may be executed in several, known ways.

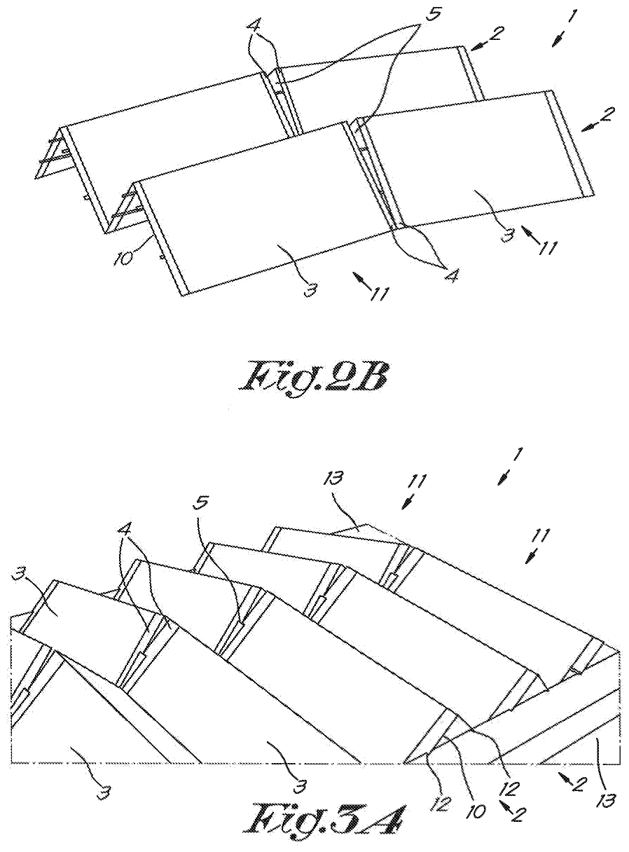

This is clearly visible in FIGS. 2a and 2b, which show the same embodiment as FIGS. 1a and 1b, but with more than two pairs 2, and in this case five pairs 2, said panels 3 resting directly or indirectly against each other, all this such that two rows 11 of panels 3 resting against each other are formed, whereby the successive panels 3 of at least one row 11 are mutually hingedly connected along their upwardly oriented edges 9, whereby said upwardly oriented edges 9 extend between the facing edges 4 and the edges 10 located opposite the aforementioned facing edges 4.

The panels 3 of each row 11 can be folded up in accordion fashion, as shown in FIG. 2b.

In the case of FIGS. 2a and 2b, both panels 3 of each pair 2 are mutually hingedly connected to a corresponding panel 3 of an adjoining pair 2 by an intermediate hinge along their upwardly oriented edges 9.

It is also possible only one panel 3 of each pair 2 is mutually connected, i.e. that only one row 10 of panels 3 is mutually hingedly connected.

The aforementioned panels 3 themselves can be executed in various ways.

In the example of FIGS. 1a to 1c, 2a and 2b, the panels 3 are made of polycarbonate roof sheets.

Of course it is also possible that only a part of the panels 3 are made from polycarbonate roof sheets, whereby the other panels 3 are manufactured or realised in a different way.

A number of possibilities are, for example, that the panels 3 are solar panels or are provided with solar panels. The result is that energy can be generated by the canopy roofing system 1.

A panel 3 may also be made from a frame with canvas, a tarpaulin or film or a sheet of greenhouse glass stretched or applied therein.

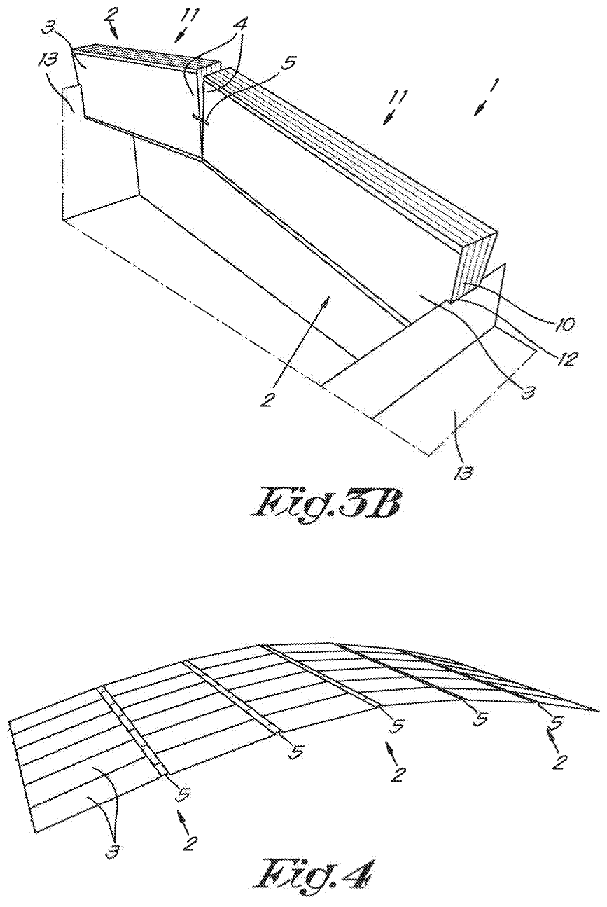

FIGS. 3a and 3b show a variant embodiment.

The difference with the embodiment of FIGS. 2a and 2b lies in the fact that the panels 3 of each pair 2 are now mutually hingedly and angularly connected in the middle of their facing edges 4 by the aforementioned top hinge 5 comprising a curved shaft 6.

The aforementioned supporting tube 8 also extends in the middle of the panel 3 or, in other words, runs across the middle of the panel 3.

Furthermore, each top hinge 5 now comprises only one such curved shaft 6.

As the top hinge 5 is located in the middle of the edge 4, the panels 3 will be balanced at all times during the tilting or rotational movement around the supporting tube 8, such that practically no forces are needed to execute the tilting-rotational movement.

Furthermore, each panel 3 on the edge 10 located opposite the aforementioned facing edge 4 is hingeably connected to a support 12.

Each panel 3 in the middle of the edge 10 located opposite the aforementioned facing edge 4 is hingeably connected to the support 12.

In particular, the support 12 will be located on the level of the extension of the supporting tube 8 in which the curved shaft 6 is mounted.

The support 12 must be understood broadly, and is an element or component with which the canopy roofing system 1 can rest or support on an underlying structure or construction which may or may not be part of the canopy roofing system 1. The support 12 may, for example, also be a post with which the canopy roofing system 1 rests on the ground.

It is possible that the embodiments of FIGS. 1a to 1c, 2a and 2b are also provided with a support 12, whereby the support 12 will not stand in the middle in this case, but will be located on the level of the extension of one of the two supporting tubes 8 of each panel 3.

In the example of FIGS. 3a and 3b the canopy roofing system 1 comprises two supporting profiles 13 or supporting beams which are arranged at a distance from each other.

The supports 12 of each pair 2 of panels 3 are each provided on one of said supporting profiles 13.

The supports 12 are movable on the supporting profiles 13, to this end they are provided with a gliding element, but this could also be a rolling element, carriage or wheel, which allows the support 12 to be movable on or in the supporting profile 13.

When the panels 3 are folded up, as shown in FIG. 3b, all the supports 12 move toward each other, such that a compact stack of panels is obtained.

In this way the canopy can be very simply pushed back or opened. This may be useful, for example when the canopy roofing system 1 is applied to an agricultural field, as a greenhouse roof or the like where depending on the weather conditions it may or may not be necessary to have a roof, lean-to or covering.

Another aspect of being able to fold up the panels 3 is when they are made of greenhouse glass, canvas, tarpaulin or the like. Such vulnerable materials need to be protected from extreme weather conditions such as for example hail.

Also in case of snow, when there is risk that a large amount of snow, and thus weight, will rest on the panels 3, such that the panels 3 are overloaded, it is useful to be able to fold up said panels 3 to avoid them collapsing under the heavy weight.

The supporting profiles 13 can be borne or intended to be borne by supports posts or the like. Alternatively, one or both supporting profiles 13 can also be attached to a wall or an adjoining building or construction.

The supporting profiles 13 can also be attached to a building, whereby the canopy roofing system 1 can serve as the roof of the building.

It is possible that the supporting profiles 13 are provided with a drain channel to collect and transport, for example rainwater that falls on the panels and due to the fact that the panels 3 are angular will run in the direction of the supporting profiles 13, to a reservoir or the like.

When the canopy roofing system 1 is used for agricultural fields, the collected rainwater can be used for irrigation purposes.

The supporting profiles 13 can hereby be provided with water sprinklers which spray the collected water, or water collected elsewhere, on the fields and crops.

It is also not excluded that electricity or power cables are provided in or to said supporting profiles 13.

In an embodiment, the supporting profiles 13 may be provided with channels provided for this purpose in which the aforementioned electricity or power cables can be laid.

This will allow transporting, on the one hand, any energy generated by solar panels with which the panels 3 are equipped or, on the other hand, to supply power to certain facilities with which the canopy roofing system 1 is equipped.

A possibility is providing simulation lighting, i.e. lighting which is able to simulate daylight, when the canopy roofing system 1 is used as a greenhouse roof or as a canopy for an agricultural field.

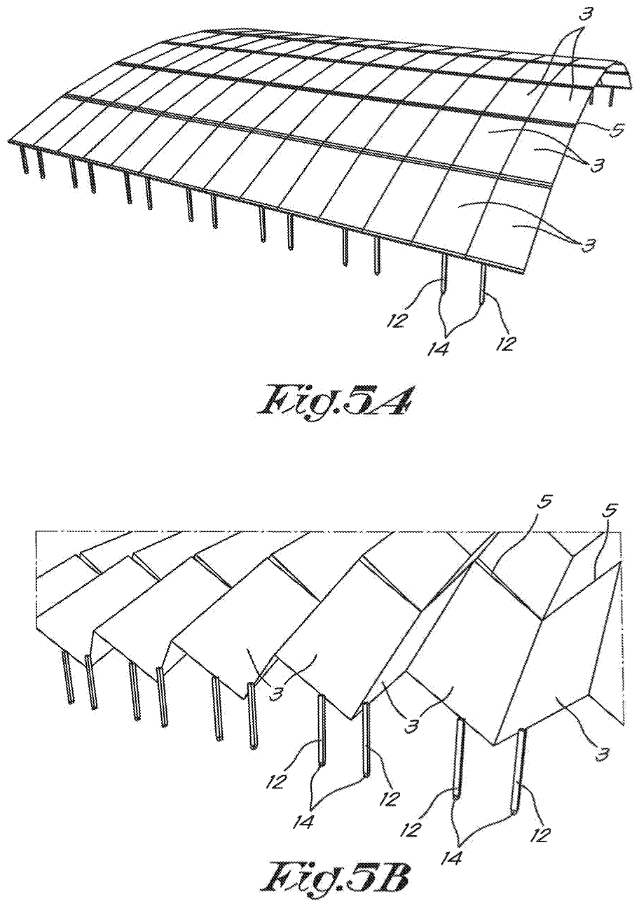

FIG. 4 shows an alternative embodiment, whereby a panel 3 on the edge 10 located opposite the aforementioned facing edge 4 is hingeably connected to an adjoining successive pair 2 of panels 3.

The connection is realised using an aforementioned top hinge 5.

FIG. 4 shows six panels 3 that are connected to each other in this way to form a very wide canopy.

As shown in FIGS. 3a and 3b, the top hinge 5 may be located in the middle of the aforementioned facing edge 4 or, as shown in FIGS. 1a to 2b may not be located in the middle.

Because the panels 3 are angularly connected relative to each other, such long distance can be spanned.

Several panels 3 have also been installed behind each other such that a wide, arc-shaped construction is formed, which can be used for stadiums or the like, for example.

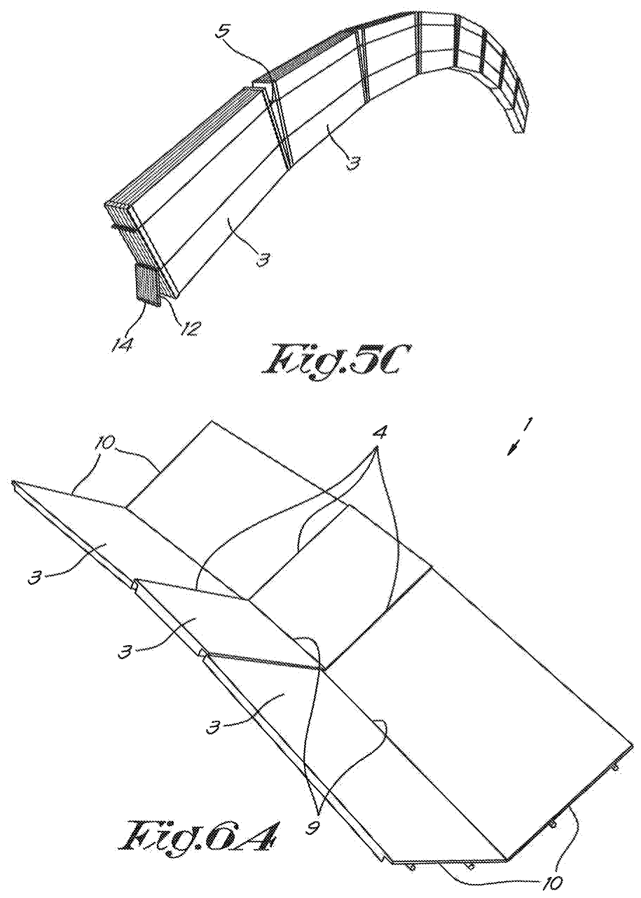

FIGS. 5a to 5c show a practical realisation of a canopy roofing system 1 shown in FIG. 4, whereby in this case the outer panels 3 are provided with a support 12 in the form of a post, said post being provided with a wheel 14 at the base that can drive, or is movable, in a rail not shown on the FIGS.

As shown in the FIGS. 5a to 5c, the post is not located in the middle of the edge 10 located opposite the facing edge 3.

This is clearly visible in FIG. 5b which also shows how the panels 3 are folded up, as it were, like a concertina or in accordion fashion by moving the posts toward each other.

FIG. 5c clearly shows how compact the panels 3 are folded up then.

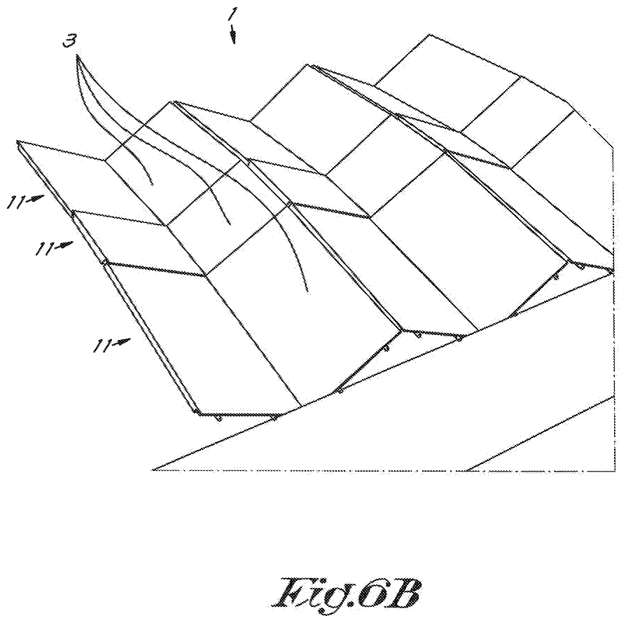

FIGS. 6a and 6b show an application of a ship's cargo hold canopy.

FIG. 6a shows the principle, while FIG. 6b shows a practical embodiment.

In broad outlines this application is the same as the application shown in, for example, FIGS. 1a to 1c and FIGS. 2a and 2b.

The difference being that in this case three panels 3 are now adjoining, such that three rows 11 of panels 3 are created.

Departing from the embodiment of FIGS. 2a and 2b, whereby the two panels 3 of each pair 2 of panels 3 on the edges 10 located opposite the facing edges 4 are provided with a support 12, only one of the panels 3 is now provided with a support 12 and the other panel 3 is coupled to an adjoining panel 3, whereby said adjoining panel 3 is in turn provided with a support 12.

In this case, the middle panel 3 is executed smaller than the two other panels 3.

For the sake of completeness it is noted that in all embodiments described and shown above it is also possible that not all panels 3 are the same size.

Also, only the middle panels 3 will be mutually coupled to each other by intermediate hinges. The two rows 10 of outer panels 3 are not connected.

Although in the embodiment shown in FIGS. 6a and 6b, the top hinges 5 are not located in the middle of the facing edges 4 of the panels 5, it is obviously not excluded that this is the case.

An additional element that may be applied in all aforementioned and shown embodiments, is providing a wire cable that is coupled to the supports 12 of a row 11 of panels 3, such that the wire cable connects all supports 12 of a row 11.

It is also possible to connect the panels 3 of both rows 11 of panels 3 with a wire cable.

A winch is also provided which allows the wire cable to be wound up.

When winding up the wire cable, the supports 12 will move toward each other, such that the panels 3 will tilt and the panels 3 are folded up.

For moving or pushing the supports 12 away from each other again, the canopy roofing system 1 may be provided with appropriate structure, such as for example a motor or the like which drives one of the supports 12.

However, in most cases this will not be necessary, as the supports 12 will automatically slide away from each other under the influence of the weight of the panels 3.

Additionally, a support 12 of each row 11 of panels 3 may be provided with a brake or the like which allows securing or blocking a support 12 temporarily such that said support is not movable on the supporting profile 13.

In some embodiments, the two extreme or outer supports 12 of each row 11 of panels 3 are provided with such brake.

By providing a support 12 and folding up the panels 3, the stack of panels 3 can be moved on the supporting profiles 13.

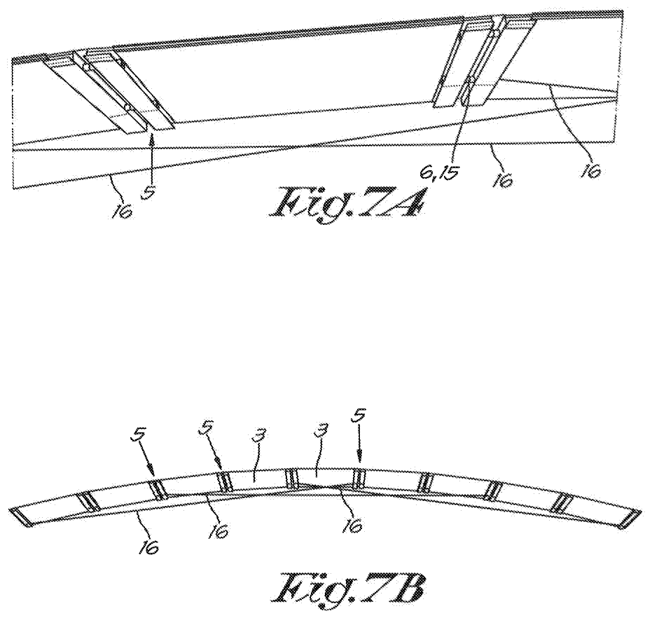

FIGS. 7a and 7b show a variant of FIG. 4.

FIG. 4 shows the situation whereby a wide canopy is realised by connecting six panels 3 to each other by top hinges 5, to form a very wide canopy.

In FIGS. 7a and 7b as well a number of, in this case nine, panels are connected to each other. Although only one chain of nine panels 3 is shown for the sake of clarity, obviously it is not excluded that various chains are installed behind each other, analogue to FIG. 4.

The curved shaft 6 of the top hinge 5 is flexible in this case.

The result is that the angle at which the panels 3 of the different adjoining pairs 2 are hingedly connected along their facing edges 4 is variable or may be adapted.

An aspect of this is that the canopy roofing system is lent a certain flexibility, such that forces as a result of, for example, wind, can be accommodated better such that the construction is stronger than with an inflexible or rigid shaft.

Furthermore, the most suitable angle can also be chosen, contrary to a non-flexible curved shaft 6, where the angle is always fixed.

The curved shaft 6 comprises, in the case of FIGS. 7a and 7b, a spring 15.

This spring 15 may be a die spring for example.

This spring 15 will provide the necessary flexibility to the curved shaft 6 and the top hinge 5, such that the angle between the two panels 3 connected by the top hinge 5, is not fixed, but can be variable.

It is also possible to execute the flexible curved shaft 6 in many different ways.

FIG. 7b shows that two flexible curved shafts 6 connecting various adjoining successive panels 3 are connected by a cable 16 or the like.

In this case three such cables 16 are provided, which are each applied between two different flexible shafts 6.

By suitably choosing the length of the cable 16, the angle between the panels 3 can be set or chosen.

In this way, the angles between the different panels 3 may vary, whereby the angle may be greater in panels 3 located on the edge of the arc and less in panels 3 located in the middle of the arc.

Consequently, the shape of the arc can be chosen freely.

FIG. 7b only shows one possible way in which cables 16 can be pulled tight between the different flexible shafts 6. This may be realised in many different ways and will chiefly depend on the desired angles between the panels 3.

It is understood that the flexible curved shaft 6 in the form of a spring 15 can also be applied in all aforementioned embodiments.

The present disclosure is not limited to the embodiments described as an example and shown in the drawings, but a canopy roofing system according to the present disclosure can be realised in all kinds of forms and dimensions, without departing from the scope of the present disclosure.

1. A canopy roofing system which comprises at least two successive pairs of panels, whereby each pair of panels comprises two panels resting directly or indirectly against each other, whereby the panels of each pair are mutually hingedly and angularly connected along their facing edges by a top hinge comprising a curved shaft, whereby at least one panel of each of the successive pairs of panels is mutually hingedly connected along their upwardly oriented edges, whereby the upwardly oriented edges extend between the facing edges and the edges located opposite the aforementioned facing edges.

2. The canopy roofing system according to claim 1, wherein the panels of each pair are mutually hingedly and angularly connected in a middle of their facing edges by the aforementioned top hinge comprising a curved shaft.

3. The canopy roofing system according to claim 1, wherein both panels of each of the successive pairs of panels are mutually hingedly connected along their upwardly oriented edges.

4. The canopy roofing system according to claim 1, wherein each panel on the edge located opposite the aforementioned facing edge is hingeably connected either to a support or to adjoining successive pairs of panels.

5. The canopy roofing system according to claim 4, wherein each panel in a middle of the edge located opposite the aforementioned facing edge is hingeably connected either to a support or to adjoining successive pairs of panels.

6. The canopy roofing system according to claim 4, further comprising two supporting profiles which are arranged at a distance from each other and that the supports of the two panels are each provided on one of the supporting profiles.

7. The canopy roofing system according to claim 6, wherein the supports are movably provided on the supporting profiles.

8. The canopy roofing system according to claim 1, wherein the canopy roofing system comprises more than two pairs of panels directly or indirectly resting against each other, all this such that two rows of panels resting against each other are formed, whereby the successive panels of at least one row are mutually hingedly connected along their upwardly oriented edges, whereby the upwardly oriented edges extend between the facing edges and the edges located opposite the aforementioned facing edges.

9. The canopy roofing system according to claim 1, wherein at least one panel of each of the successive pairs of panels is mutually hingedly connected by an intermediate hinge whereby the intermediate hinges are such that they allow the panels to be folded toward each other in accordion fashion.

10. The canopy roofing system according to claim 9, wherein each panel of each of the successive pairs of panels is mutually hingedly connected by an intermediate hinge.

11. The canopy roofing system according to claim 1, wherein the aforementioned curved shaft of the top hinge is able to rotate with its free ends in two supporting tubes, each provided on one panel of the relevant pair of panels, whereby the supporting tubes extend in the direction of the upwardly oriented edges of the panels.

12. The canopy roofing system according to claim 11, wherein characterised in that the aforementioned top hinge is provided with a flexible canvas, tarpaulin or the like which is applied between at least a section of the two facing edges of the two panels resting upwardly against each other.

13. The canopy roofing system according to claim 1, wherein at least a part of the panels is provided with solar panels or that at least some of the panels are solar panels.

14. The canopy roofing system according to claim 1, wherein at least a part of the panels is composed of a frame with a canvas, tarpaulin, greenhouse glass or film stretched in the frame.

15. The canopy roofing system according to claim 1, wherein at least some the panels are made from polycarbonate roof sheets.

16-28. (canceled)

29. The canopy roofing system according to claim 2, wherein that both panels of each of the successive pairs of panels are mutually hingedly connected along their upwardly oriented edges.

30. The canopy roofing system according to claim 29, wherein each panel on the edge located opposite the aforementioned facing edge is hingeably connected either to a support or to adjoining successive pairs of panels.

31. The canopy roofing system according to claim 30, wherein each panel in the middle of the edge located opposite the aforementioned facing edge is hingeably connected either to a support or to adjoining successive pairs of panels.

32. The canopy roofing system according to claim 31, further comprising two supporting profiles which are arranged at a distance from each other and that the supports of the two panels are each provided on one of the supporting profiles.

33. The canopy roofing system according to claim 32, wherein the supports are movably provided on the supporting profiles.
